(19) United States
(12) Patent Application Publication
(10) Pub. No.: US 2023/0036949 A1
(43) Pub. Date: Feb. 2, 2023

(54) END SHIELD FOR A ROTARY ELECTRIC MACHINE

(71) Applicant: VALEO EQUIPEMENTS ELECTRIQUES MOTEUR, Creteil Cedex (FR)

(72) Inventors: Khalid SASSANE, Creteil Cedex (FR); Rafael SANTOS, Creteil Cedex (FR); Matthieu BONNICI, Creteil Cedex (FR); Jean-Luc TARRAGO, Creteil Cedex (FR); Alain DEFEBVIN, Creteil Cedex (FR); Mohammed KRIKEB, Creteil Cedex (FR)

(73) Assignee: VALEO EQUIPEMENTS ELECTRIQUES MOTEUR, Creteil Cedex (FR)

(21) Appl. No.: 17/783,499

(22) PCT Filed: Dec. 7, 2020
(86) PCT No.: PCT/EP2020/084934

§ 371 Date: Jun. 8, 2022

(30) Foreign Application Priority Data
Dec. 9, 2019 (FR) 19 13986

(51) Int. Cl. H02K 5/15; H02K 5/20

(52) U.S. Cl. CPC H02K 5/15; H02K 5/207

(57) ABSTRACT

An end shield for a rotary electric machine includes a plate which extends generally transversely in relation to an axis (X), and a skirt which extends generally axially from the plate. The skirt has at least one shoulder which forms an axial stop, the shoulder being intended to axially block a stator body of the rotary electric machine. The shoulder extends only over a portion of the circumference of the skirt.

The invention relates in particular to an bracket for a rotary electric machine and to a rotary electric machine comprising such an bracket, in particular for a vehicle such as a motor vehicle.

The invention is particularly advantageously applicable in the field of rotary electric machines such as alternators, starter-alternators, or even reversible machines or electric motors. It will be recalled that a reversible machine is a rotary electric machine that is able to operate reversibly, both as an electric generator when functioning as an alternator and as an electric motor for example for starting the combustion engine of the motor vehicle.

A rotary electric machine comprises a rotor that is able to rotate about an axis, and a fixed stator. In alternator mode, when the rotor is rotating, it induces a magnetic field at the stator, which converts it into electric current in order to supply power to the electrical consumers of the vehicle and to recharge the battery. In motor mode, the stator is electrically powered and induces a magnetic field causing the rotor to rotate, for example, in order to start the combustion engine.

The stator has a body forming a series of slots through which an electric winding passes that extends axially on either side of the body so as to form parts called visible portions. The stator body is mounted in two brackets forming the casing of the rotary electric machine. Conventionally, each of the brackets has a holding portion extending over the entire circumference of the stator body.

When the size of the electric machine is limited, the visible portions may be radially very close to the brackets and this may cause short circuits during operation of the rotary electric machine.

The present invention aims to allow the drawbacks of the prior art to be avoided. In particular, the invention aims to propose a rotary electric machine with a small radial size, the visible portions of which are far enough from the brackets so as not to create a short circuit while at the same time ensuring effective holding of the stator by the brackets.

To this end, the present invention therefore relates to an bracket for a rotary electric machine, having: a plate extending generally transversely with respect to an axis, a skirt extending generally axially from the plate, the skirt having at least one shoulder forming an axial stop for axially immobilizing a stator body of the rotary electric machine. According to the invention, the shoulder extends only over a portion of the circumference of the skirt.

The shoulder therefore forms a discrete axial stop element that may also be called an axial stop and makes it possible to ensure immobilization of the stator relative to the bracket by concentrating the holding of the stator only in certain zones. The shoulder therefore does not extend over the entire circumference of the stator, and this makes it possible to reduce the assembly tolerances. Thus, the radial size of the machine may be reduced while at the same time reliably preventing any movement of the stator as well as the creation of a short circuit.

In addition, the fact that the shoulder that forms the zone for holding the stator body on the bracket extends only over a portion of the circumference of the skirt makes it possible to reduce the thickness of the skirt, compared with a conventional skirt of the prior art, in all the zones that do not contribute to holding the stator body. This therefore makes it possible to reduce the weight of the bracket and therefore that of the rotary electric machine while at the same time ensuring effective holding of the stator body.

According to one embodiment, the shoulder is formed by machining. This makes it possible to improve the precision of the dimensions of the shoulder and thus to further reduce the assembly tolerances so as to increase the reduction in the dimensions of the machine while at the same time avoiding the risk of a short circuit.

According to one embodiment, the bracket has a plurality of shoulders arranged at a distance from one another along the circumference of the skirt. The skirt of the bracket therefore has at least two distinct shoulders. This makes it possible to distribute the forces for holding the stator body along the circumference of the skirt so as to limit the risk of breakage of the skirt or of poor holding of the body of the stator. Preferably, the shoulders are uniformly distributed along the circumference of the skirt. This makes it possible to balance the machine.

According to one embodiment, the skirt has at least one fastening means for contributing to the assembly between said bracket and another bracket of the rotary electric machine. According to this embodiment, the shoulder is arranged radially between the fastening means and the axis of the bracket. In other words, a portion of the shoulder is contained in a plane comprising the axis and passing through the fastening means. This makes it possible to position the shoulder in the zone in which the axial holding force may be at a maximum so as to thus improve the holding of the stator body without increasing the risks of breakage of the skirt.

According to one embodiment, the shoulders extend, in total, circumferentially over a portion less than 70% of the total circumference of the skirt. Thus, the entire bearing surface between the bracket and the stator is less than 70% of the circumference of the skirt.

According to one embodiment, the shoulders extend, in total, circumferentially over a portion greater than 20% of the total circumference of the skirt. Thus, the entire bearing surface between the bracket and the stator is greater than 20% of the circumference of the skirt.

According to one embodiment, the shoulders extend, in total, over a portion of between 25% and 40% of the total circumference of the skirt and in particular of the order of 30% to 32% such as 31%.

For example, each shoulder extends over a portion of between 5% and 10% of the total circumference of the skirt and in particular of the order of 7 to 8% of the total circumference of the skirt.

These dimensions make it possible to optimize the holding zone so as to find a good compromise between effective holding of the stator body with a reduced size of the machine, reduction in the weight of the machine and the number of the air inlet/outlet openings that make it possible to cool the machine.

According to one embodiment, the shoulder extends over an internal surface of the skirt.

According to one embodiment, the shoulder is in one piece with the skirt.

According to one embodiment, the shoulder is formed of a holding surface extending in a generally radial direction toward the axis and of a circumferential surface extending generally axially from the holding surface, said holding surface and said circumferential surface being machined. These machined surfaces make it possible to have dimensions and in particular a diameter that are very precise so as to thus reduce the assembly tolerances and be able to bring the surfaces closer to the visible portion of the winding without there being a risk of creating a short circuit while at the same time making it possible to improve the reduction of the diameter of the machine.

According to one embodiment, the circumferential surface extends from the holding surface to the plate. There is therefore no opening arranged axially between the shoulder and the plate. This makes it possible to improve the stiffness of the bracket.

Alternatively, the circumferential surface extends in a direction parallel to the axis. In other words, the machined surface forms a planar surface extending axially. This makes it possible to optimize the spacing between the skirt and the visible portion and thus reduce the risks of a short circuit.

According to one embodiment, the skirt has radial openings allowing the passage of an air flow, the shoulder extending circumferentially between two radial openings. This makes it possible to enlarge the openings, compared with a conventional bracket in which the stator body is held over the entire circumference of the skirt. The cooling of the machine is thus improved.

Preferably, at least one opening is arranged in the same radial plane as the holding surface of the shoulder. The opening is thus opposite the visible portion base, that is to say the part of the visible portions that is adjacent to the stator body. This makes it possible to improve the cooling of the visible portion of the stator, in particular at its hottest point.

The present invention also relates to a rotary electric machine having: a stator having a stator body forming slots and an electric winding housed at least partially in said slots, at least one bracket, as described above, arranged to surround, at least partially, the stator and forming an axial stop for the stator body.

According to one embodiment, the machine has a second bracket, the stator body having a shrinking zone with said second bracket. The holding force exerted by the shrinking, combined with that exerted by the shoulder, makes it possible to improve the holding of the stator body while at the same time improving the cooling of said body and reducing the size of the machine. For example, the shrinking zone also called interference fitting zone extends over the entire circumference of the second bracket and in particular over the entire circumference of the skirt of said second bracket.

The rotary electric machine may advantageously form an alternator, a starter-alternator, a reversible machine or an electric motor.

The present invention may be understood better upon reading the following detailed description of non-limiting implementation examples of the invention, and upon studying the appended drawings.

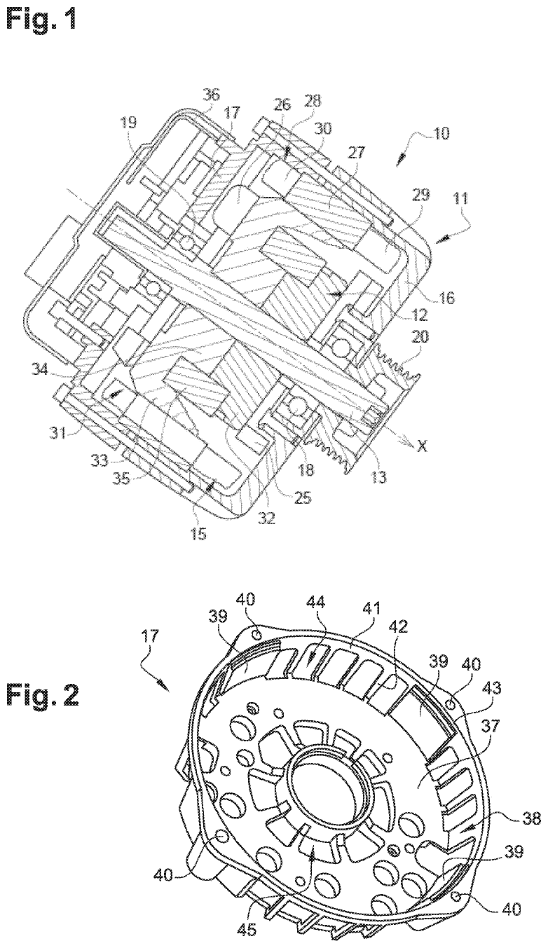

FIG. 1 shows, schematically and partially, a cross-sectional view of a rotary electric machine according to one implementation example of the invention.

FIG. 2 shows, schematically and partially, a perspective view of the inside of the first bracket according to an exemplary embodiment.

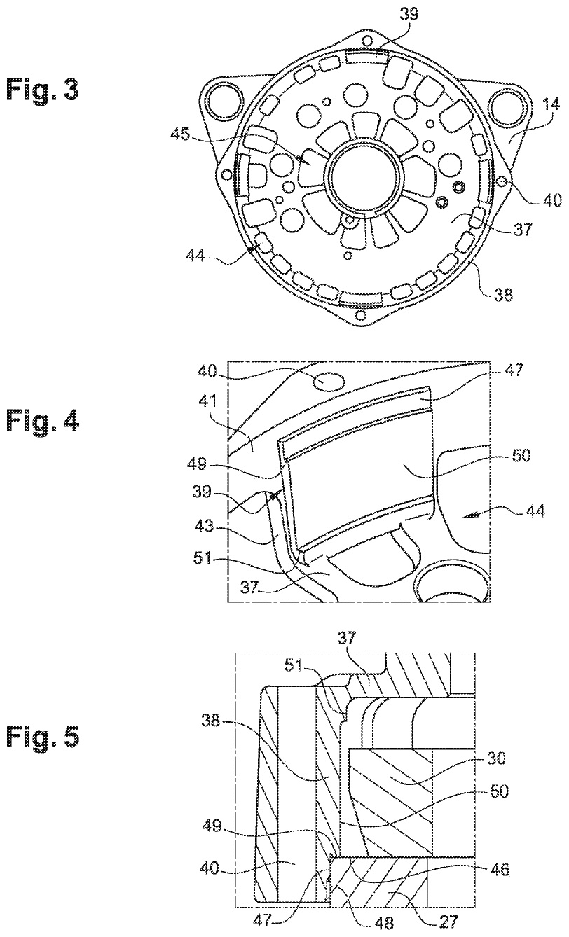

FIG. 3 shows, schematically and partially, a top view of FIG. 2.

FIG. 4 shows, schematically and partially, a perspective view of one of the shoulders in FIG. 2.

FIG. 5 shows, schematically and partially, a cross-sectional view of a part of the stator mounted in the bracket according to a variant embodiment of the bracket.

Identical, similar or analogous elements retain the same references from one figure to another. It also should be noted that the various figures are not necessarily to the same scale. Moreover, the embodiments that are described below are in no way limiting; it will be possible, in particular, to imagine variants of the invention that comprise only a selection of features described below, in isolation from the other described features. In particular, all of the variants and all of the embodiments described can be combined with each other if there is no technical reason preventing this combination.

FIG. 1 shows an example of a compact multi-phase rotary electric machine 10, in particular for a motor vehicle. This machine 10 converts mechanical energy into electrical energy, in alternator mode, and may operate in motor mode in order to convert electrical energy into mechanical energy. This rotary electric machine 10 is, for example, an alternator, a starter-alternator, a reversible machine or an electric motor.

In this example, the machine 10 has a casing 11. Inside this casing 11, the machine also has a shaft 13, a rotor 12 that rotates as one with the shaft 13, and a stator 15 surrounding the rotor 12. The rotational movement of the rotor 12 takes place about an axis X. In the rest of the description, the axial direction corresponds to the axis X, which passes through the shaft 13 at the center thereof, while the radial orientations correspond to planes that are concurrent, and in particular perpendicular, to the axis X. For the radial directions, the term inner corresponds to an element that is oriented toward the axis, or that is closer to the axis with respect to a second element, and the term outer denotes a distance from the axis.

In this example, the casing 11 has a front bracket 16 and a rear bracket 17 that are joined together. These brackets 16, 17 are of hollow shape and each centrally bear a bearing coupled to a respective ball bearing 18, 19 for the rotational mounting of the shaft 13. In addition, the casing 11 has holding means 14 allowing the rotary electric machine 10 to be mounted in the vehicle.

A drive member such as a pulley 20 may be fastened to a front end of the shaft 13. This member makes it possible to transmit the rotational movement to the shaft or allows the shaft to transmit its rotational movement to the belt. In the rest of the description, the designations front/rear refer to this member. Thus, a front face is a face oriented in the direction of the member, while a rear face is a face oriented in the direction away from said member.

The rear end of the shaft 13 bears, in this case, slip rings belonging to a commutator, which is not shown. Brushes belonging to a brush holder, which is not shown, are disposed so as to rub against the slip rings. The brush holder is connected to a voltage regulator (not shown).

The front bracket 16 and the rear bracket 17 may have substantially lateral openings for the passage of an air flow in order to allow the cooling of the machine 10 through air circulation brought about by the rotation of a front fan 25 arranged on a front axial face of the rotor 12 and of a rear fan 26 arranged on a rear axial face of said rotor.

In this example, the rotor 12 is a claw-pole rotor having two claw poles 31. Each claw pole 31 is formed of a plate 32 oriented transversely, of a plurality of claws 33 forming magnetic poles and of a cylindrical core 34. The rotor has a coil 35 wound around the core. For example, the slip rings belonging to the commutator are connected by wire connections to said coil 35. The rotor 12 may also have magnetic elements, such as permanent magnets, interposed between two adjacent claws 33. Alternatively, the rotor may be formed of a pack of laminations housing permanent magnets forming the magnetic poles.

In this exemplary embodiment, the stator 15 has a body 27 formed of a pack of laminations that is provided with slots, which are equipped with slot insulator for the mounting of an electric winding 28. The winding passes through the slots in the body 27 and forms a front visible portion 29 and a rear visible portion 30 on either side of the body of the stator. Furthermore, the winding 28 is formed of one or more phases having at least one electrical conductor and being electrically connected to an electronic assembly 36.

The electronic assembly 36, which in this case is mounted on the casing 11, has at least one electronic power module allowing at least one phase of the winding 28 to be driven. The power module forms a bridge voltage rectifier for converting the generated AC voltage into a DC voltage, and vice versa.

FIG. 2 more specifically illustrates a first bracket of the rotary electric machine 11, this bracket being, in the example described here, the rear bracket 17. The rear bracket is in this case the bracket on which the electronic assembly 36 is mounted.

The bracket 17 has a plate 37 extending generally transversely with respect to an axis of the bracket that in this case corresponds to the axis X of rotation of the machine. The plate has in this example a central opening forming the bearing that is coupled to the ball bearing 19.

The bracket also has a skirt 38 extending generally axially from one end of the plate 37, said end being opposite the end forming the bearing.

In the example illustrated, the skirt 38 has a plurality of shoulders 39 each forming a surface forming an axial stop that makes it possible to immobilize, in an axial direction, the stator body 27. Each of the shoulders 39 extends only over a portion of the total circumference of the skirt and over an internal surface of the skirt. The stator is thus axially immobilized at a plurality of points that are distinct from one another along the circumference of the skirt.

For example, the skirt has four shoulders 39. Said shoulders may be of identical shape and size to one another.

The shoulders 39 may be arranged so as to be angularly uniformly distributed along the circumference of the skirt 38. In other words, the adjacent shoulders have the same spacing from one another along the circumference of the skirt.

Each shoulder is in particular positioned, in this case, so as to be radially between the axis X and a fastening means 40 of the bracket 17. The fastening means is in particular a means for fastening the rear bracket 17 to the front bracket 16. For example, said means 40 may be a hole arranged to receive a fastening element such as a screw or a tie rod. The skirt 38 has a projecting portion, extending in a radial direction toward the outside, which has the attachment means. As is visible in FIG. 3, the skirt has four assemblies each having a shoulder 39 and an associated fastening means 40. Said assemblies are arranged so as to be opposite one another in pairs with respect to the axis X and in particular uniformly distributed along the circumference of the skirt.

In the example illustrated here, each shoulder 39 extends circumferentially over a portion of the order of 8% of the total circumference of the skirt. Still in this example, the sum of the circumferential widths of the shoulders 39 is of the order of 32% of the total circumference of the skirt.

The skirt 38 has an annular portion 41 forming the free end of said skirt, in an axial direction, a plurality of arms 42 and a plurality of holding portions 43 each bearing a shoulder 39 for holding the stator body 27. Said arms and said holding portions each extend in a generally axial direction between said annular portion 41 and the plate 37. Each holding portion 43 has a circumferential width greater than those of the arms 42.

Radial openings 44 are arranged between two successive arms 42 and between an arm 42 and a holding portion 43. Said openings form air passages that make it possible to cool the rotary electric machine. Preferably, the radial openings 44 are arranged so as to each be opposite a portion of the rear visible portion 30 of the winding 28 of the stator. In addition, the radial openings 44 are extended axially so as to extend between two shoulders 39 forming the axial stop surface for the stator body 27. In particular, said openings 44 are arranged so as to each be opposite a base portion of said visible portion, the base portion of the visible portion being a portion adjacent to the stator body. This makes it possible to improve the cooling of the machine by allowing evacuation of the stagnant hot air on the internal radial part of the visible portion by allowing the air flow entering axially, via axial openings 45 formed in the plate 37, to push the stagnant air out of the chamber of the machine via the openings 44.

FIG. 4 more specifically illustrates an exemplary embodiment of the shoulder 39. The shoulder is integral with the holding portion 43 and forms a projection in a radial direction toward the axis X.

The stator body 27 is mounted in contact with the shoulder 39 such that said shoulder forms an axial stop surface or an axial stop allowing the stator body to be held in an axial direction. Thus, as is visible in the example in FIG. 5, a portion of the radial external periphery 48 of the stator body 27 is in contact with a first circumferential surface 47 of the holding portion 43 of the skirt 38 and an outer portion of the axial end surface 46 of the stator body 27 is in contact with a holding surface 49 extending radially from the circumferential surface 47 so as to form the shoulder 39. Preferably, the shoulder 39 is formed by machining. In particular, said surface 47 and said radially extending surface 49 are machined.

The free end of the holding surface 49 is extended in a generally axial direction by a second circumferential surface 50. Thus, the shoulder is formed by the holding surface 49 and the second circumferential surface 50. Said surface 50 is preferably machined.

In the example illustrated in FIG. 4, the circumferential surface 50 extends axially between the holding surface and the plate 37. The plate may have a shoulder 51 forming an axial projection extending as far as the circumferential surface so as to simplify the operation of machining said surface.

The circumferential surface 50 extends alongside the rear visible portion 30. Said surface extends parallel to the X axis.

The front bracket 16 of the rotary electric machine 10 may have at least one shoulder as described above. Thus, the bracket 16 may have a shape similar to that of the rear bracket 17. The stator body 27 is then mounted tightly between the two brackets 16, 17 on the holding surfaces 49 forming the shoulders 39.

Alternatively, the stator body 27 is interference fitted onto the front bracket 16 and the rear bracket 17 allows said body to be immobilized in an axial direction.

The present invention is applicable in particular in the field of alternators or electric motors, but it could also be applied to any type of rotary machine.

Of course, the above description has been given only by way of example and does not limit the field of the present invention, which would not be departed from by replacing the various elements with any other equivalents.

1. A bracket for a rotary electric machine, having:
a plate extending generally transversely with respect to an axis (X),
a skirt extending generally axially from the plate, the skirt having at least one shoulder forming an axial stop for axially immobilizing a stator body of the rotary electric machine;
the bracket being wherein the shoulder extends only over a portion of the circumference of the skirt.

2. The bracket as claimed in claim 1, wherein it has a plurality of shoulders arranged at a distance from one another along the circumference of the skirt.

3. The bracket as claimed in claim 1, wherein the skirt has at least one fastening means for contributing to the assembly between said bracket and another bracket of the rotary electric machine and in that the shoulder is arranged radially between the fastening means and the axis (X) of the bracket.

4. The bracket as claimed in claim 1, wherein the shoulders extend, in total, circumferentially over a portion less than 70% of the total circumference of the skirt.

5. The bracket as claimed in claim 1, wherein the shoulder is formed of a holding surface extending in a generally radial direction toward the axis (X) and of a circumferential surface extending generally axially from the holding surface, said holding surface and said circumferential surface being machined.

6. The bracket as claimed in claim 5, wherein the circumferential surface extends from the holding surface to the plate.

7. The bracket as claimed in claim 5, wherein the circumferential surface extends in a direction parallel to the axis (X).

8. The bracket as claimed in claim 1, wherein the skirt has radial openings allowing the passage of an air flow, the shoulder extending circumferentially between two radial openings.

9. A rotary electric machine having:
a stator having a stator body forming slots and an electric winding housed at least partially in said slots, and
at least one bracket, as claimed in claim 1, arranged to surround, at least partially, the stator and forming an axial stop for the stator body.

10. The machine as claimed in claim 9, wherein the machine has a second bracket, the stator body having a shrinking zone with said second bracket.

11. The bracket as claimed in claim 2, wherein the shoulders extend, in total, circumferentially over a portion less than 70% of the total circumference of the skirt.

12. The bracket as claimed in claim 2, wherein the shoulder is formed of a holding surface extending in a generally radial direction toward the axis (X) and of a circumferential surface extending generally axially from the holding surface, said holding surface and said circumferential surface being machined.

13. The bracket as claimed in claim 6, wherein the circumferential surface extends in a direction parallel to the axis (X).

14. The bracket as claimed in claim 2, wherein the skirt has radial openings allowing the passage of an air flow, the shoulder extending circumferentially between two radial openings.

15. A rotary electric machine having:
a stator having a stator body forming slots and an electric winding housed at least partially in said slots, and
at least one bracket, as claimed in claim 2, arranged to surround, at least partially, the stator and forming an axial stop for the stator body.

16. The bracket as claimed in claim 3, wherein the shoulders extend, in total, circumferentially over a portion less than 70% of the total circumference of the skirt.

17. The bracket as claimed in claim 3, wherein the shoulder is formed of a holding surface extending in a generally radial direction toward the axis (X) and of a circumferential surface extending generally axially from the holding surface, said holding surface and said circumferential surface being machined.

18. The bracket as claimed in claim 3, wherein the skirt has radial openings allowing the passage of an air flow, the shoulder extending circumferentially between two radial openings.

19. A rotary electric machine having:
a stator having a stator body forming slots and an electric winding housed at least partially in said slots, and
at least one bracket, as claimed in claim 3, arranged to surround, at least partially, the stator and forming an axial stop for the stator body.

20. The bracket as claimed in claim 4, wherein the shoulders extend, in total, circumferentially over a portion less than 70% of the total circumference of the skirt.
